(19) United States
(12) Patent Application Publication
(10) Pub. No.: US 2007/0144383 A1
(43) Pub. Date: Jun. 28, 2007

(54) Composite pad printing plate

(76) Inventors: Kenneth J. Klann, Vadnais Heights, MN (US); Jason Cody Bates, Corpus Christi, TX (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/522,108

(22) Filed: Sep. 15, 2006

Related U.S. Application Data
(60) Provisional application No. 60/752,528, filed on Dec. 21, 2005.

(51) Int. Cl. B41N 1/00

(52) U.S. Cl. 101/395

(57) ABSTRACT

A composite printing plate having a body including a first surface and a generally opposed printing surface, the body made of a polymeric matrix and a plurality of beads dispersed in the polymeric matrix. The plate further including a design in the printing surface defined by a base and an upper margin generally coplanar with the printing surface, wherein some of the beads extend from the base towards the upper margin, such that the at least some of the beads are at least partially exposed in the design.

### RELATED APPLICATION

The present application claims the benefit of U.S. Provisional Application No. 60/752,528, entitled “Composite Pad Printing Plate,” filed Dec. 21, 2005, which is incorporated herein in its entirety by reference.

### FIELD OF THE INVENTION

The present invention relates generally to printing plates. More particularly, the present invention relates to a composite printing plate for use in various pad printing processes.

### BACKGROUND OF THE INVENTION

Those involved in printing operations have used pad printing processes to print onto various objects, such as glassware, balls, pens, and other objects having various shapes and configurations. In general, a rubber printing pad on conventional pad printing equipment picks up an ink image disposed in a plate image or reservoir on a printing plate and transfers the ink image to an object. The reservoir that holds the ink is engraved, etched, or otherwise formed onto the surface of the printing plate.

Conventional pad printing equipment includes open inkwell and sealed ink cup systems. In open inkwell pad printing systems, a spatula scoops ink out of an inkwell presented on a printing plate and over the printing surface, including a design reservoir defined on the plate. The system also includes a blade or scraper positioned at a distance from the printing plate surface as the spatula scoops ink out of the open inkwell and over the printing surface. After the spatula fills the reservoir, the scraper is positioned on the plate surface and moved over the plate surface to remove excess ink while leaving the ink in the reservoir.

After the scraper has moved over the plate, the ink in the reservoir that is exposed to the air becomes tacky while the non-exposed ink below the exposed ink remains liquid and relatively non-tacky. The printing pad is pressed against the inked plate and lifted. Because the exposed ink on the ink design has become tacky, the pad is able to lift the ink design out of the reservoir. As the printing pad moves toward the object to be printed upon, fresh ink can be deposited onto the plate and into the design reservoir.

Once the ink design is removed from the reservoir, the newly exposed ink on the other side of the ink image also becomes tacky. The printing pad can move to the object, press the ink image upon the object, and transfer the ink image onto the object. The ink image can be transferred from the printing pad to the object because the surface energy of the silicone rubber printing pad is relatively low as compared to the surface energy of the object. In addition, the peeling effect imparted between the ink image and printing pad due to the shape of the printing pad further enables the transfer.

In the sealed ink cup pad printing process, an ink cup having an open bottom is moved over the design reservoir to deposit ink into the reservoir. The pad printing plate is then moved with the lips of the cup removing any excess ink off the image area and retaining a seal between the ink cup and printing plate. The printing pad is then pressed onto the exposed, inked image. The printing pad picks up the image from the pad printing plate. With the ink image of the image on the printing pad being slightly tacky, the printing pad moves to the object, presses upon the object, and transfers the ink image onto the object.

In both the open inkwell and sealed ink cup processes, ink is deposited over a pad printing plate and into a design reservoir defined on the pad printing plate. Because the scrapers and ink cup lips in conventional systems can be weighted or otherwise biased to the plate to effectively scrape or wipe the ink off of the plate surface, the scrapers and ink cup lips can “dip” below a top margin of the design reservoir and into the reservoir as it moves across the plate. In some systems, any pressure placed upon the scraper can further cause the scrapers and ink cup lips to dip below the top margin.

The aforementioned dipping can cause the scraper to scrape or otherwise pull ink from the intermediate portions of a design defined on the plate, leaving an uneven layer of ink in the reservoir. However, it is generally desirable to retain the ink evenly in the reservoir as the scraper passes over the well. In other words, it is not desirable to have more ink retained near the edges of the design than in the intermediate portions of the design, a result that can occur when a scraper moves over the reservoir. When this happens, the ink image on the pad does not have an even thickness and can lack any ink in the intermediate portions of the ink image. This can lead to poor image transfer onto an object.

Conventional methods have been developed in an attempt to provide structure in the design reservoir to inhibit the scraper from dipping below the plate surface as it passes over the design. These include defining or presenting bumps, ribs, or other structure in the reservoirs. Some of the conventional methods that are used to create the design on the face of a plate with structures to inhibit the scraper from dipping below the plate surface include photosensitive emulsion processes, sandblasting or etching steel plates, and the wax-dipping of an anodized aluminum plate and removal of the wax in the design area.

In the photosensitive emulsion processes, a photosensitive emulsion is placed on a blank plate on all areas of the plate surface except the desired design. Next, an ultraviolet (UV) light is exposed over the entire plate to remove material in the areas not covered with emulsion. This can leave a reservoir in the shape of the desired design. A grid or checkerboard pattern of the photosensitive emulsion can then be placed over the design. The plate is again exposed to UV light. This creates a grid or checkerboard pattern on the design that can provide structure to inhibit the scraper from dipping into the reservoir when scraping the plate surface. However, the multiple steps needed to create a design in a plate using the photosensitive emulsion process can lead to significant turnaround times. In addition, the photosensitive emulsion process is generally quite expensive and results in an abundance of waste emulsion material.

To make a steel pad printing plate, a steel plate having a granular surface structure is provided. The plate is covered with another plate or mask having the design presented therein. The hardened steel plate is then either sandblasted or etched so that the design is created on the face of the plate. The sandblasting or etching will etch away some of the grains of the structure while leaving others. This process can leave a surface having some grains within the design that inhibits the ink from being removed from intermediate portions of the reservoir during the scraping step. Like the photosensitive emulsion process, however, the processing times needed to create a design in a plate using this process can be quite long. Also, this process can produce a large amount of waste blasting or etching material.

Anodized aluminum having an irregular surface finish has also been used to create a pad printing plate. The plate is dipped in wax and the excess wax is removed from the plate to provide the plate with a generally planar surface. The wax remains in crevices formed by the irregular surface finish. A low-power laser or other heat source is then used to melt or otherwise remove the wax from the areas of the desired design, with the design being formed on the face of the plate. The portions of the irregular surface can provide structure to inhibit the ink from being removed from intermediate portions of the reservoir during the scraping. The wax-dipping process can require significant processing time and can also produce a large amount of waste material.

As can be seen, there are numerous deficiencies with conventional printing plates. For example, the long processing times needed to create a design in a plate using the above methods can lead to significant turnaround times. In addition, the conventional methods described above are generally quite expensive and result in an abundance of expensive waste material. Waste materials resulting from the conventional methods used to make plates include emulsion, sandblasting or etching material, and wax.

As such, there is an ongoing need for improved plates and processes for forming the plates.

### SUMMARY OF THE INVENTION

A composite pad printing plate in accordance with the present invention substantially solves the above problems of conventional printing plates. The plate images hereof can be formed with a laser etching process as applied to a composite plate. Beads carried in the composite plate are exposed when a design is laser etched or otherwise engraved in the composite plate. The beads can then provide a physical barrier to a scraper dipping into the design, thus inhibiting excessive removal of ink from a design reservoir of a printing plate so formed.

The composite printing plate broadly includes a body having a first surface and a generally opposed printing surface, the body made of a polymeric matrix and a plurality of beads dispersed in the polymeric matrix between the surfaces. The polymeric matrix can be made of, for example, thermosets, thermoplastics, any copolymers thereof, and any blends thereof. The beads can be made of, for example, glass, elemental metal, any alloys or compounds thereof, and any combinations thereof.

The composite printing plate also includes a design selectively presented in the printing surface that is defined by a base and a generally opposed margin generally coplanar with the printing surface, wherein at least some of the beads extend from the base towards the margin, such that at least some of the beads are at least partially exposed in the design. The design can generally be made by a one-step laser etching process, which can significantly reduce the manufacturing times associated with conventional printing plates.

An aspect of the present invention is that the exposed beads each can extend from the base to the margin, such that the surface points are generally coplanar with the printing surface. The surface points can effectively inhibit a scraper used in the printing process from dipping below the margin, and thus inhibit ink from being removed from the design. In addition, the beads can be spherical, which can enable a scraper to easily pass over the beads when the surface point is generally coplanar with the printing surface.

A further aspect of the present invention is that the plate can include particles comprised of elemental metal particles dispersed in the matrix to add additional desirable properties to the plate. Elemental metal as used herein refers to both elemental metals and any compounds thereof. Such particles can include magnetic particles such as, for example, iron, any alloys thereof, and any combinations thereof. The iron particles can be used to operably magnetically couple the plate to printing equipment.

Another aspect of the present invention is that the plate can include a binding agent disposed intermediate the beads and the matrix to inhibit movement of the beads relative to the matrix. The binding agent can also inhibit beads from falling out of the design when the scraper moves across the beads or when the design replication is removed from the design reservoir.

The printing plates of the present invention can be used to transfer a design replication onto a substrate. First, a printing plate as described is provided and the design is at least partially filled with print material. A feature and advantage of the present invention is that one or more blades can be provided that are operably engageable with the printing surface. Movement of the blades can be effected to remove print material on the printing surface, with the partially exposed beads inhibiting the blade from removing print material from the design between the beads and base.

### BRIEF DESCRIPTION OF THE DRAWINGS

FIG. 1 is a perspective view of a pad printing plate according to a first embodiment of the present invention depicting an empty design reservoir presented on a printing surface of the plate;

FIG. 2A is a cross-sectional view taken along line 2A-2A of FIG. 1;

FIG. 2B is a cross cross-sectional view taken along line 2B-2B of FIG. 1, depicting spherical beads homogeneously dispersed in a matrix material;

FIG. 3 is a cross-sectional view of a pad printing plate according to a second embodiment, depicting spherical beads and secondary particles homogeneously dispersed in a matrix material;

FIG. 4 is a cross-sectional view of a pad printing plate according to a third embodiment, depicting spherical beads and secondary particles dispersed in separate layers of matrix materials;

FIG. 5 is a block diagram of an open inkwell pad printing system, depicting ink being moved across plate surface with a spatula and an ink image being transferred by a printing pad, the printing plate being depicted in a cross-sectional view;

FIG. 6 is similar to FIG. 5, but with the ink image being transferred onto an object;

FIG. 7 is similar to FIG. 5, but with the scraper removing excess ink from the plate surface;

FIG. 8 is a perspective view of the pad printing plate of FIG. 1, the design reservoir filled with ink up to an upper margin of the design reservoir;

FIG. 9 is a cross-sectional view taken along line 8-8 of FIG. 7;

FIG. 10 is a front elevational, schematic view of a printing pad transferring an ink image from a design reservoir defined on a pad printing plate, the printing plate being depicted in a cross-sectional view through the design reservoir;

FIG. 11 is a side elevational, schematic view of the printing pad of FIG. 11, with the printing pad transferring an ink image from the design reservoir defined on the pad printing plate, the printing plate being depicted in a cross-sectional view through the design reservoir;

FIG. 12 is a cross-sectional view taken from the perspective of line 12-12 of FIG. 10, depicting a plurality of gaps formed in the ink image by the beads in the reservoir;

FIG. 13 is a schematic diagram of an ink cup pad printing system depicting a ink being moved across plate surface with an ink cup and an ink image disposed on a printing pad, the printing plate being depicted in a cross-sectional view;

FIG. 14 is similar to FIG. 13, but with the ink image being transferred onto an object by the printing pad; and

FIG. 15 is similar to FIG. 13, but with the ink cup removing excess ink from the plate surface after the design reservoir has been filled.

### DETAILED DESCRIPTION OF THE DRAWINGS

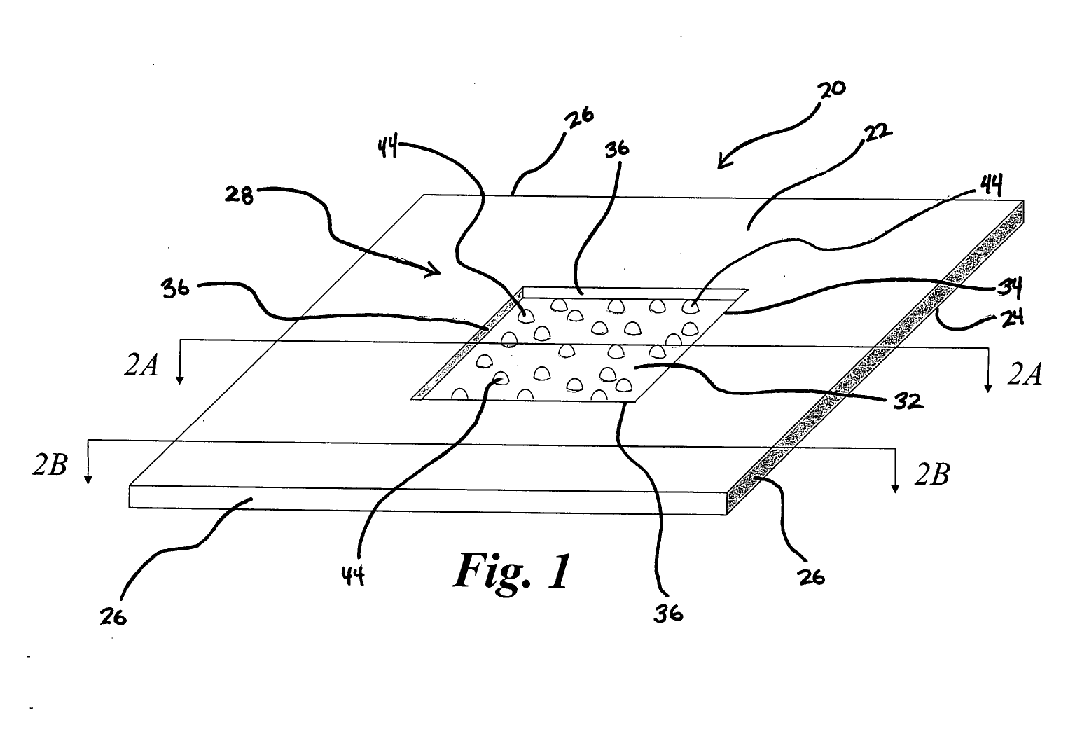

FIG. 1 depicts a composite pad printing plate 20. The pad printing plate 20 can be used in pad printing processes, such as open inkwell and sealed ink cup pad printing processes, to retain ink in the shape of a desired design and inhibit ink near intermediate portions of a reservoir from being removed during the printing processes.

The pad printing plate 20 broadly includes a first, top or printing surface 22, a generally opposed second, bottom surface 24, and one or more edges 26 presented thereon, the number of edges 26 depending upon the general shape of the plate 20. For example, square or rectangular plates can comprise four edges and other polygonal plates can comprise any number of edges. A plate having a circular, oval, or generally arcuate shape can comprise one, generally continuous edge. The plate 20 further includes a design reservoir 28 formed on the printing surface 22.

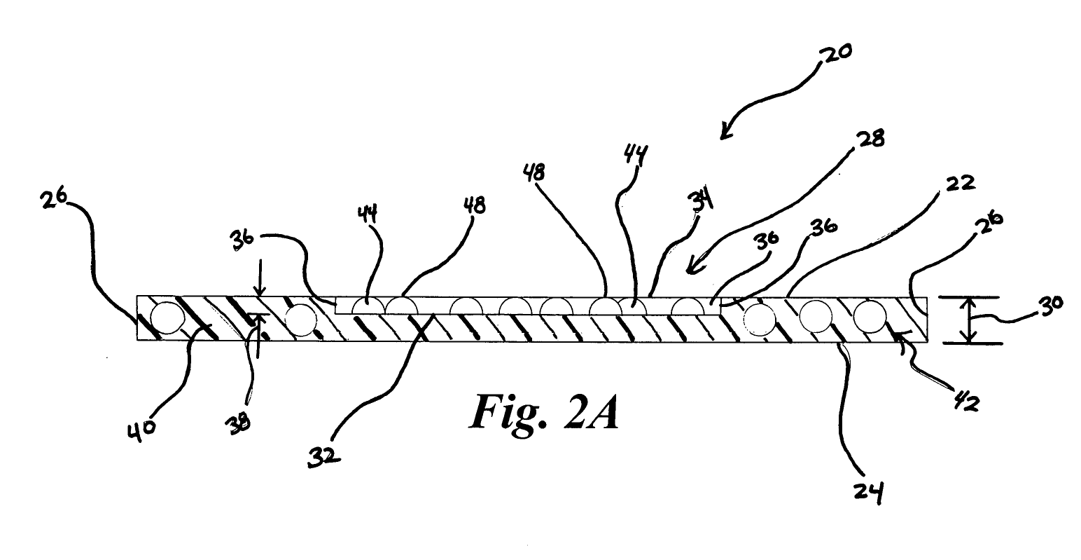

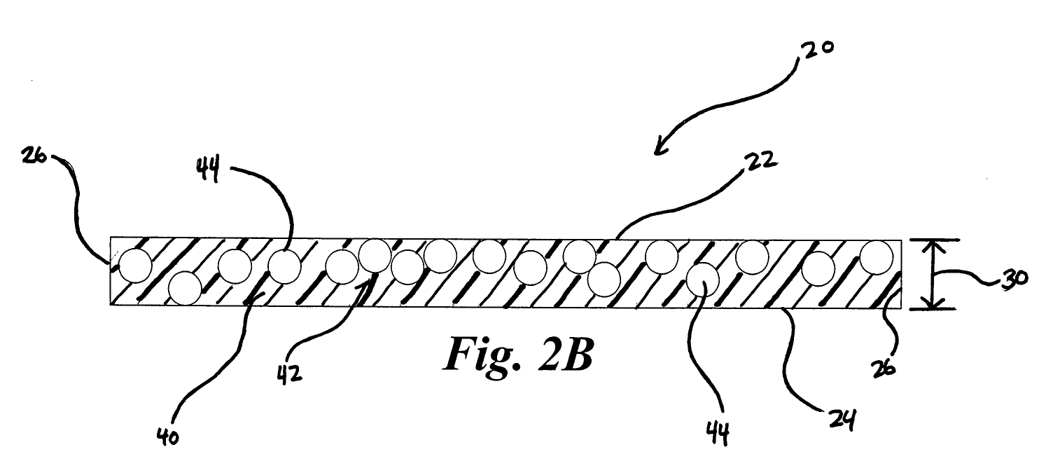

Referring to FIGS. 2A and 2B, which depict cross-sectional views of the printing plate 20 of FIG. 1, the composite plate 20 also presents a thickness 30 that is generally defined between the first and second surfaces 22, 24. The thickness 30 of the plate 20 can be between 1/64 inch and ½ inch. Preferably, for pad printing processes, the thickness 30 is about 1/32 inch. The thickness 30 of the plate 20 can be selected based upon various factors, such as cost and rigidity. For example, as the thickness of the plate decreases, the overall rigidity also decreases. As the thickness of the plate increases, the overall cost also increases.

While the thickness 30 has been described as being between 1/64 inch and ½ inch, those skilled in the art will recognize that other plate thicknesses less than 1/64 inch and greater than ½ inch can be used. Further, a person of ordinary skill in the art will also recognize that additional ranges within the explicit ranges given above are contemplated and are within the present disclosure.

Referring to FIGS. 1 and 2A, the reservoir 28 can comprise a reservoir base 32 and a reservoir top margin 34 that can be generally co-planar with the top surface 22 of the plate 20. The reservoir 28 also generally includes one or more reservoir edges 36 defined therein extending between the reservoir base and reservoir top margin 34. The reservoir 28 also generally includes a plurality of beads 44 exposed therein. The beads 44 are described in greater detail herein with respect to the composite plate 20 materials.

Referring to FIG. 2A, the reservoir 28 generally further comprises a reservoir depth 38 that is presented between the reservoir base 32 and reservoir top margin 34. The depth 38 of the reservoir 28 can be between 0.001 inch and 0.002 inch and will generally define the thickness of the ink image being transferred to an object. Preferably, for pad printing processes, the depth 38 of the reservoir 28 is between 0.001 inch and 0.0015 inch. The depth 38 of the reservoir 28 can be selected based upon various factors, such as the thickness of the ink image to be transferred and the size of beads 44. For example, the reservoir depth 38 can be between about 30% and about 70% of the average diameter of the beads 44. While the depth 38 has been described as being between 0.001 inch and 0.0015 inch, those skilled in the art will recognize that other depths less than 0.001 inch and above 0.0015 inch can be used. Further, a person of ordinary skill in the art will also recognize that additional ranges within the explicit ranges given above are contemplated and are within the present disclosure.

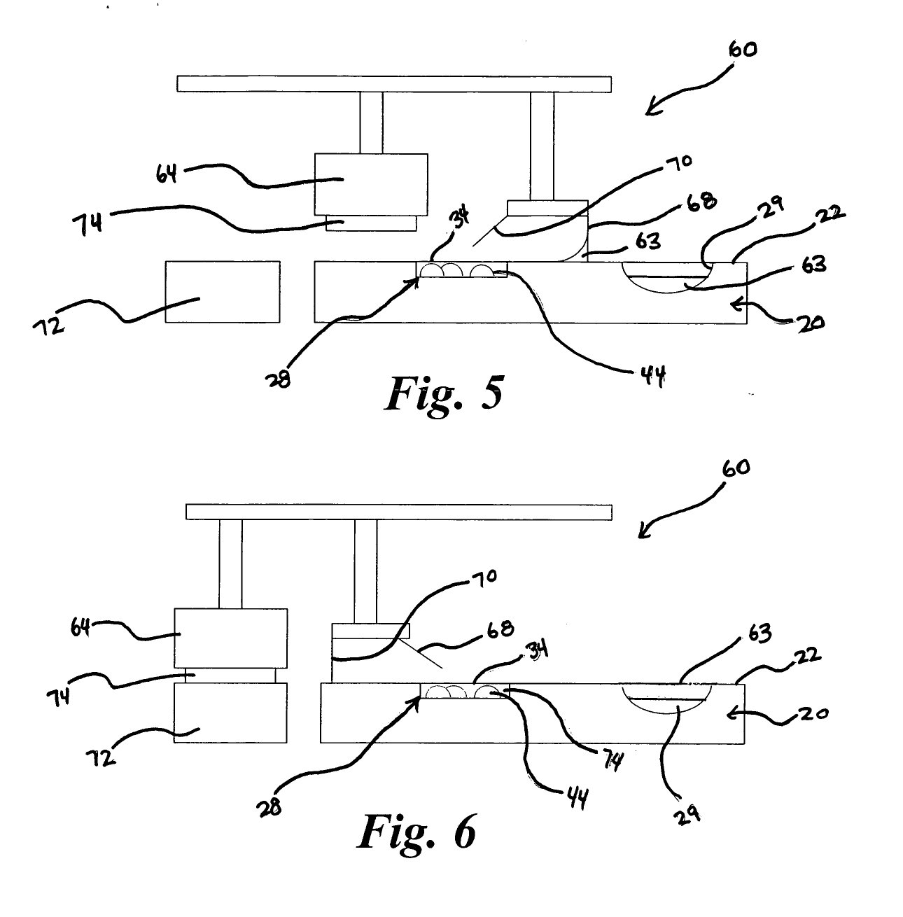

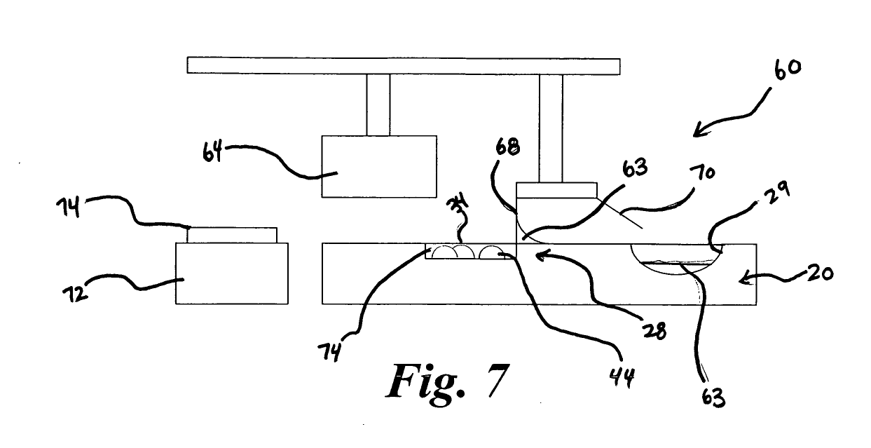

Referring to FIGS. 5-7, the printing plate 20 can also comprise an inkwell 29 that can be used to retain ink 63 for use in the open inkwell pad printing process. The open inkwell pad printing process will be described in greater detail herein with respect to FIGS. 5-7.

Referring to FIGS. 2A and 2B, the composite plate 20 of a first embodiment can be comprised of a combination of a polymer matrix 40 and a filler 42 dispersed therein, the filler 42 being comprised of beads 44 (such as glass beads) dispersed in the polymer matrix 40. As will be described in greater detail below, the filler 42 can also comprise additional particles in addition to, or in place of, the beads 44.

The composite material can be comprised of any ratio of matrix material 40 to filler material 42. The ratio of matrix material 40 to filler material 42 can be selected depending on many variables including desired material properties, such as hardness to inhibit deformation, chemical resistance to resist the effects of the ink, coefficient of friction to inhibit friction between a scraper and the plate, thermal conductivity, magnetism, and flammability. The ratio of matrix material 40 to filler material 42 can also be selected depending on desired cost of the plate 20. In embodiments in which the filler material comprises glass beads, the plate 20 can comprise between about 20 wt. % and about 75 wt. % filler material 42. At about 20 wt. %, there can be too few beads in proximity with each other to inhibit removal of ink during scraping processes. At about 75 wt. %, the matrix material can be at such a level that it will not effectively fill the spaces between the beads. Preferably, the plate 20 comprises between about 40 wt. % and about 60 wt. % filler material 42. Optimally, the composite material comprises about 50 wt. %±about 5 wt. % filler material 42. A person of ordinary skill in the art will recognize that additional ranges within the explicit ranges given above are contemplated and are within the present disclosure.

The polymer matrix 40 can be any number of engineering materials that generally comprise sufficient laser etchability. In addition, preferable matrix materials also can comprise high thermal resistance for use in high temperature applications and high chemical resistance to withstand the general solvent properties of ink. Preferable matrix material 40 includes thermoplastics, thermosets, copolymers thereof, and blends thereof. For example, some matrix material 40 includes acetal homopolymer, PBT (polybutylene terephthalate), polyethylene such as PET (polyethylene terephthalate), polypropylene, and polystyrene. An example of an acetal homopolymer is acetal resin under the trade name Delrin® by E.I. du Pont de Nemours and Company, DuPont Building, 1007 Market Street, Wilmington, Del. 19898. Other matrix material 40 can include PPS (polyphenylene sulfide), PETG (glycol-modified polyethylene terephthalate), cellulosics, polyester, ABS (acrylonitrile, butadiene, styrene), fluoropolymers, silicones, nylons, polyurethane.

Acetal is a preferable matrix material because it vaporizes easily. When used in conjunction with filler material 42, such as glass beads 44, the acetal vaporizes easy while the glass beads 44 do not. This enables a reservoir to be laser etched into the top surface 22 of the plate 20 leaving a plurality of glass beads 44 exposed in the reservoir 28 to inhibit ink from being removed from intermediate portions of the reservoir 28 during the scraping process step. PET and PBT are also preferable matrix materials because of their high laser etchability.

As described above, the filler material 42 can comprise beads 44, such as oxide glass beads. As depicted generally in the figures, the beads 44 are preferably substantially spherical in shape, but can be other generally rounded shapes. As will be described in greater detail below, the spherical shape of the beads 44 can enable a scraper to more easily move over the beads when removing excess ink from the top surface of the plate. In addition, the spherical shape of the beads 44 enables only a relatively small portion of the bead surface, such as a point 46 of the bead 44, to be exposed when ink is disposed in the reservoir 28 and the surface of the beads 44 are coplanar with the upper margin 34 of the reservoir 28. In other words, a straight line of the upper margin 34 of the reservoir 28 is tangent to the surface of the bead 44 at point 46. By only having relatively small portion of the bead surface of the bead 44 or point 46 exposed, only a relatively small area or hole will be created in an ink design 74, which will fill in with liquid ink when the ink design 74 is removed from the reservoir 28 by a printing pad and pressed onto an object.

While the plate according to the invention has been described as having a polymeric matrix with beads dispersed therein, the beads being substantially spherical in shape or other generally rounded shapes, those skilled in the art will recognize that other shaped particles having angled or irregular surfaces can be used.

The beads 44 can be sized such that they comprise average particle diameters between about 0.0004 inch and about 0.039 inch or between about 0.0029 inch and about 0.0059 inch Such beads 44 can pass through a sieve having mesh sizes between about mesh size 100 and about mesh size 200. Preferably, such beads 44 comprise average particle dimensions of about 0.002 inch. A person of ordinary skill in the art will also recognize that additional ranges within the explicit ranges given above are contemplated and are within the present disclosure. Referring to FIG. 2B, the spherical beads 44 can be dispersed generally equally or homogeneously throughout the plate 20 between the top and bottom surfaces 22, 24 and the edges 26.

Other beads 44 that can be used with the plate include iron, any alloys thereof (e.g., plain carbon or stainless steel), or any combinations thereof. In embodiments in which the beads 44 comprise iron or any alloys thereof, the plate 20 can comprise between about 40 wt. % and about 90 wt. % filler material 42. Iron or steel can be used when it is desirable to reflect laser light during laser etching of the design reservoir in the plate 20 and inhibit any heating of the matrix material 40 on the underside of the beads 44. In addition, the magnetic properties of the iron or steel beads can enable attaching the printing plate 20 to magnetic or metal processing equipment. Other materials that can be used for the beads are ceramics and various laser resistant polymers.

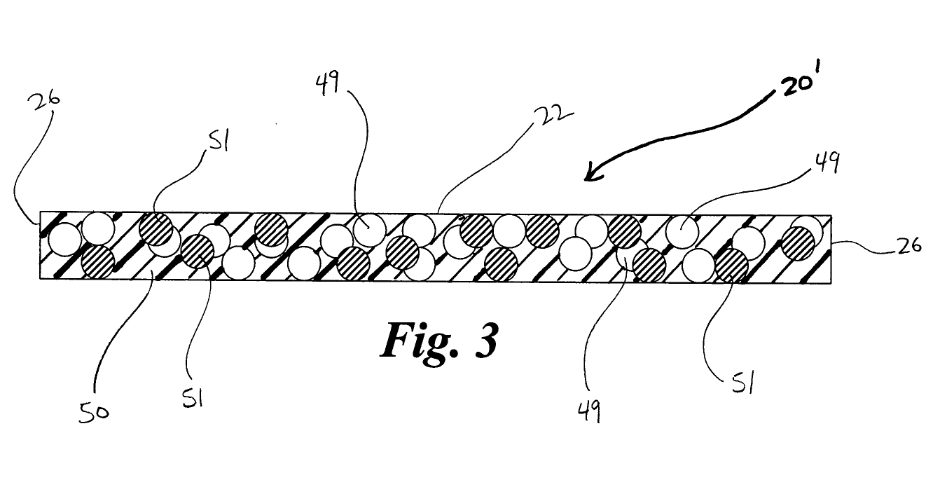

Referring to FIG. 3, the composite plate 20′ of a second embodiment can be comprised of a combination of a polymer matrix 50 having a filler therein, the filler being comprised of beads 49 and elemental metal particles 51 dispersed in the polymer matrix 50. The elemental metal particles 51 can be coated with a polymer such as ULTEM® resin, which is an amorphous thermoplastic polyetherimide. The elemental metal particles 51 can be coated with a polymer to inhibit the breakdown of the surrounding polymer matrix at melt temperatures. Without a coating, in certain circumstances, the uncoated elemental metal particles exposed to the polymer matrix at melt temperatures can cause the polymer matrix, such as PBT or Delrin, to break down into gas.

The filler of the composite plate 20′ of the second embodiment can be comprised of between about 40 wt. % and about 60 wt. % of the beads and between about 40 wt. % and about 60 wt. % of the particles or between about 45 wt. % and about 55 wt. % of the beads and between about 45 wt. % and about 55 wt. % of the particles. While being generally described as being elemental iron herein, the particles 51 can be elemental aluminum, copper, nickel, stainless steel, or carbon particles, or any alloys or combinations thereof.

The beads 49 can be the same as the beads 44 described above with respect to the first embodiment, although those skilled in the art will recognize that the beads 49 in the second embodiment can be altered from beads 44. The metal particles 51 in the second embodiment can be sized such that they comprise average particle dimensions between about 0.0004 and about 0.039 inches. Preferably, the metal particles comprise average particle dimensions less than about 1.5 times the average dimension of the beads. As used herein, average particle dimension means the average of the dimension in each of the three major axes. In a sphere, average particle dimension generally equals average particle diameter. A person of ordinary skill in the art will also recognize that additional ranges within the explicit ranges given above are contemplated and are within the present disclosure.

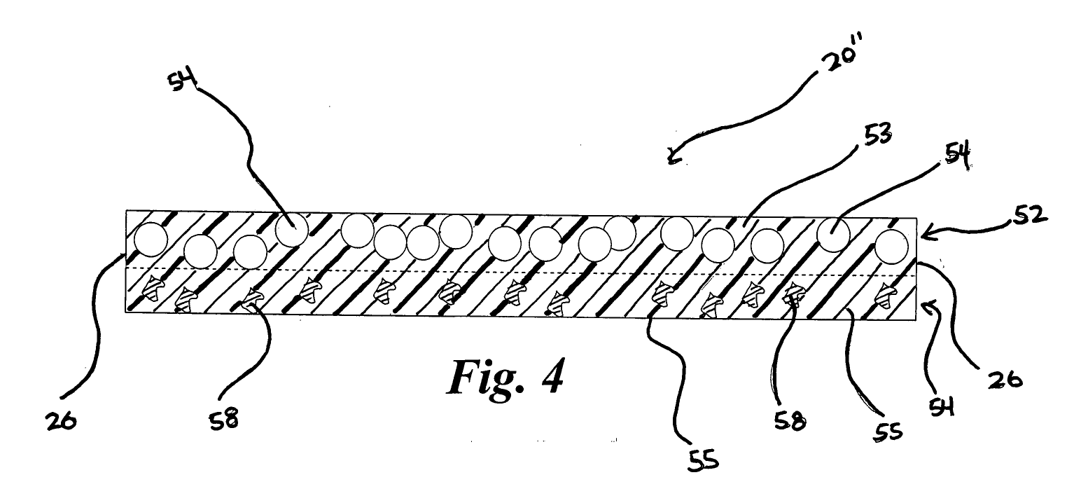

While the particles 51 can be spherical as depicted in FIG. 3, the elemental metal particulates can also be irregularly shaped (FIG. 4), flakes, and/or fibers dispersed within the polymeric matrix. A person of ordinary skill in the art will recognize that additional elemental metal particles 51 can be used as filler materials. Such elemental metal particles 51 can be selected for any number of desired properties, such as thermal conductivity, magnetism, hardness, and other material properties. For example, such particle can comprise a hardness of about 350 Vickers Hardness Number to inhibit any flattening of the particles as the blade passes thereover. Referring to FIG. 3, the spherical beads 49 and particles 51 can be dispersed generally equally or homogeneously throughout the plate 20 between the top and bottom surfaces 22, 24 and the edges 26.

Referring to FIG. 4, in the composite plate 20″ of a third embodiment, beads 54 and particles 58 can be selectively more or less concentrated in specific portions of the plate 20″, such as in first and second layers 52, 56, respectively. In this embodiment, the plate 20″ can comprise glass beads 54 in a greater concentration in a first matrix 53 proximate the first top surface 22 and elemental metal particles 58, such as elemental iron or any alloys thereof, in a greater concentration in a second matrix 55 proximate the second bottom surface 24. The plate 20″ can enable the top surface 22 to be used to form a reservoir therein and the bottom surface to be magnetic for coupling to metal or other magnetic backing on the pad printing equipment. For example, in ink cup printing processes, the plate can be coupled to a metal plate included on the ink cup equipment.

In the third embodiment of the plate 20″, the particles 58 can be larger than the particles 51 in the second embodiment of the plate 20′, as the particles 58 are on an underside of the plate 20″ and generally not in layer 52 being etched. While being generally described as being elemental iron, the particles 58 can be elemental iron, aluminum, copper, nickel, stainless steel, or carbon particles, or any alloys or combinations thereof.

The plates 20, 20′, 20″ can be somewhat porous. Such porosity can be less than twenty volume percent of the plate 20, 20′, 20″. Preferably, the porosity is substantially zero porosity in the plate 20, especially proximate the top surface 22, as porosity can lead to holes or pits on the first surface of the plate. The holes or pits can retain ink therein when a scraper is used to clear material off of the first surface. The ink retained in the holes or pits can then be picked up by the printing pad and transferred to the object to be printed up, leaving an undesirable image on the object.

To make the plate of the first and second embodiments 20, 20′, the matrix 40 and filler material 42 (such as glass beads 44 in the first embodiment or glass beads 49 and particles 51 in the second embodiment) are selected. Once the matrix 40 and filler material 42 have been selected, the matrix and filler materials 40, 42 are mixed to form a composite material mixture. Generally, the matrix material 40 can be mixed in pellet form with the filler material 42. Alternatively, the matrix material 40 can be melted and then mixed with filler material 42 to form the composite material mixture. If the matrix material 40 is to be mixed in powder form, a wetting agent can be used to prevent the matrix material 40 from becoming airborne. In addition, a wetting agent can be used in conjunction with the filler material 42 to prevent the filler material from becoming airborne prior to extruding.

The composite material mixture is then placed in a hopper of extruder. When the composite matrix material contains pellet-form matrix material, the matrix material is melted during extrusion and effectively mixed with the powder filler material, conveyed in the extruder, and then extruded. When the matrix material contains melted matrix material, the melted matrix material is mixed with powder filler material during extrusion. The composite material is then conveyed and extruded in an extruder.

A binding agent can also be used in conjunction with the composite plate material. The binding agent can be used to inhibit the beads from falling out of the plate after the design reservoir is etched therein and a scraper is used to remove excess ink from the plate. Such adhesives can include liquid silicon, such as Dow Corning 200® Fluids, Those skilled in the art will recognize that other materials could be used to inhibit the beads from falling out of the plate, such as other liquid polymer adhesives.

In other embodiments, such as the bi-layer embodiment of FIG. 4 or tri-layer embodiments, two or three screws can be used to form each of the layers of the composite material. The layers are pinched, polymer welded, fused (e.g., with molded plate portions), or otherwise joined together to form a plate having a bi-layer or tri-layer structure.

Those skilled in the art will recognize that the plates 20, 20′, and 20″ can be formed by other forming processes, such as by injection molding or other molding processes. In addition, plates comprised of thermosets can be mixed, placed in a shaped tray, and enabled to cure.

A carbon dioxide (CO₂) laser can be used to etch the selected design or wording onto the plate blank. An example of a carbon dioxide (CO₂) laser platform is sold by Universal Laser Systems, Inc., of Scottsdale, Arizona. Stock material of the composite material can be inserted and placed on a work area of the carbon dioxide (CO₂) laser. Such a work area can comprise dimensions of, for example, 24 inches×12 inches. In a large system, the work area can comprise dimensions of, for example, 24′×12′. The stock material can comprise various dimensions up to the dimensions of the work area on the laser platform.

Other lasers that can be used to etch the design 28 into the plate 20, 20′, 20″ can include Nd:YAG lasers, ruby lasers, and various diode lasers. Those of skill in the art will recognize that other lasers can be used to etch the design reservoir 28 into plates 20, 20′, 20″.

A desired design to be etched into the plate blank can be programmed into a computer and/or controller that are operably coupled to the laser system. The stock material can be positioned on the work area, which can include ruler guides to aid in positioning the material. Once the material is in place, a cover on the system can be closed and the laser can begin to etch the material. If the stock material is larger than the plates 20, 20′, 20″, the laser system can cut the plate 20, 20′, 20″ out of the larger stock material. In addition, if positioning holes or tabs are desired, the laser system can cut the positioning holes or tabs out of the plate 20, 20′, 20″. The positioning holes can be used for precise registration of the plate.

The laser can be powered between about five and two hundred and fifty Watts. Optimally, the laser is powered at thirty five Watts and the laser etching is performed at ten percent of thirty five Watts. The laser can be run at between one and one thousand pluses per inch and above, and preferably at one thousand pulses per inch. In alternative units, the laser can be run at fifty thousand pulses per second. The laser can be run between one tenth of an inch and two hundred inches per minute and above, and preferably at two hundred inches per minute.

The plates 20, 20′, 20″ can be used in conventional pad printing processes, such as, for example, the open inkwell or sealed ink cup processes.

Referring to FIGS. 5-7, an open inkwell pad printing system 60 is depicted. An open inkwell pad printing system 60 generally comprises a pad printing plate 20 with a reservoir 28 and an inkwell 29 defined therein. The open inkwell pad printing system 60 also generally comprises a spatula 68 and blade or scraper 70 operably engageable with the plate 20 and operably coupled to a printing pad 66.

In the open inkwell pad printing system 60, the spatula 68 scoops ink 63 out of the open inkwell 29 and onto the surface 22 of the plate 20, including into a design reservoir 28 defined thereon. While the plate 20 depicted and described with respect to the open inkwell pad printing system 60 is the plate 20 according to the first embodiment, the plates according to the second and third embodiments 20′, 20″ can be used. A scraper 70 included on the system is off of the plate top surface 22 when the spatula 63 scoops ink out of the open inkwell and over the top surface 22 of the plate 20. After ink 63 has been deposited into the reservoir 28, the scraper 70 then moves over the top surface 22 of the pad printing plate 20 and removes excess ink from the pad printing plate 20 while leaving the ink image 74 in the reservoir 28 up to the top margin 34.

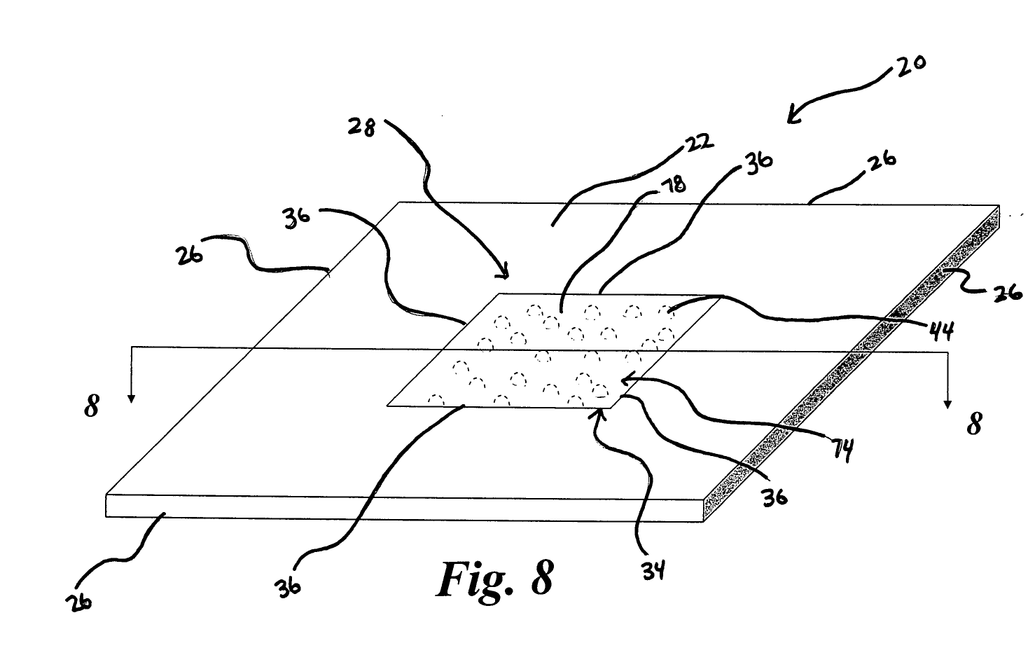

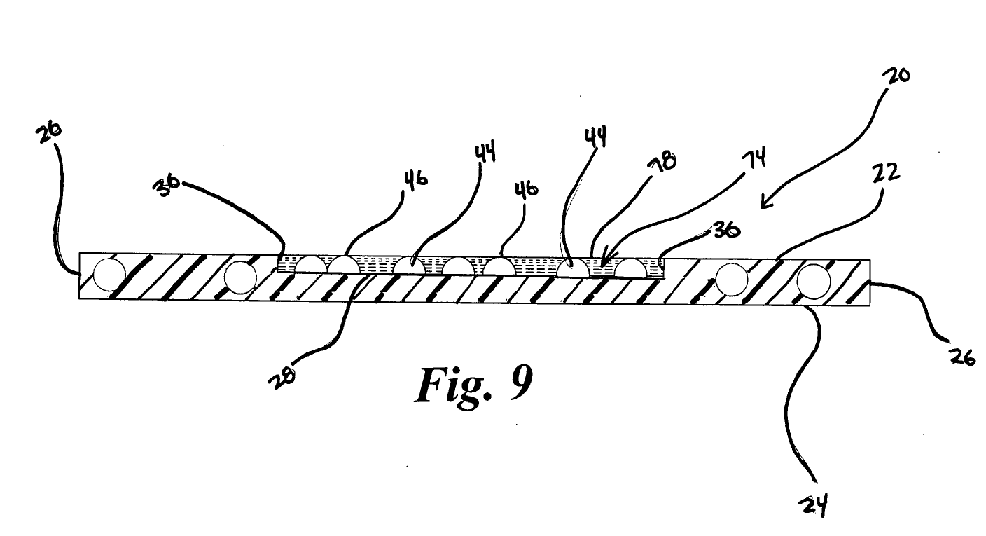

Referring to FIGS. 8 and 9, the glass beads 44 inhibit the ink design 74 from being removed from intermediate portions of the reservoir 28 during the scraping. A reservoir 28 in a plate 20 having beads 44 is depicted. As can be seen, the top exposed surface 78 of the ink 74 in the reservoir 28 is generally level. In addition, the glass spheres depicted in FIGS. 8 and 9 can keep the ink off of the bottom of the reservoir, thus enabling ease of ink removal from the reservoir by a printing pad.

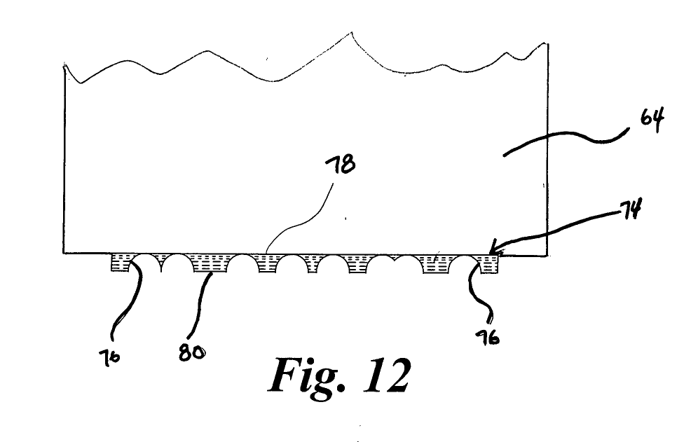

Referring again to FIGS. 8 and 9, the exposed surface 78 on the top of the ink image 74 generally will become tacky while the ink below the exposed surface 78 on the top of the ink image 74 remains liquid and relatively non-tacky. There is initially generally no ink in the areas where the glass beads reside leaving gaps (FIG. 12). A printing or printing pad 64 is then pressed against the inked plate 20 and lifted.

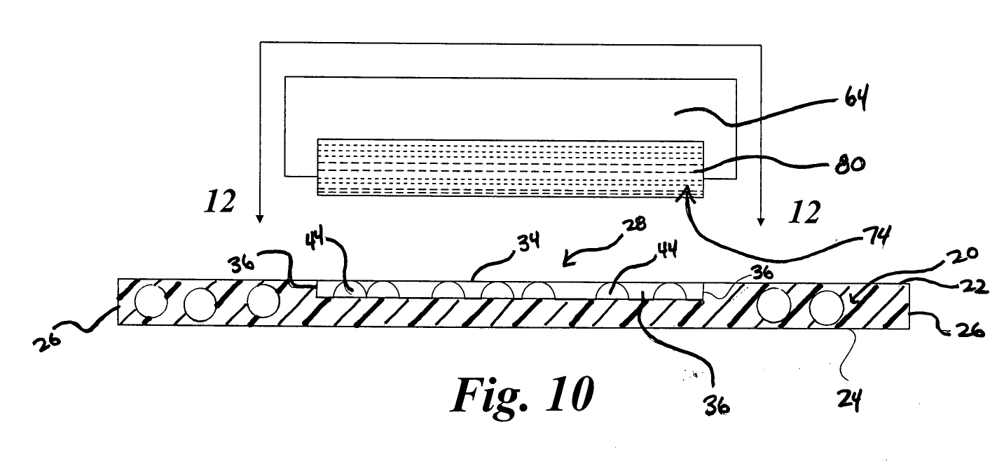

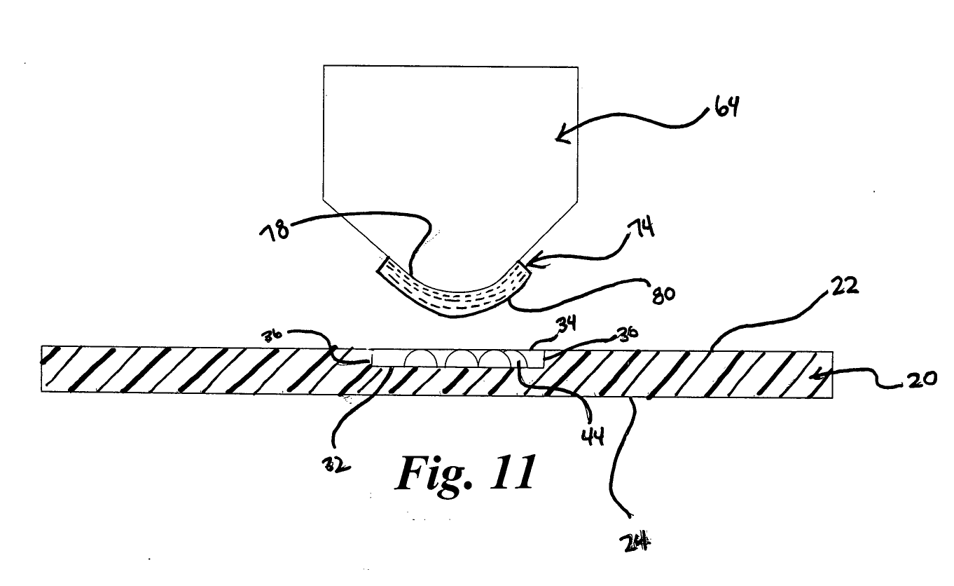

Referring to FIGS. 10 and 11, which depict the ink image 74 on the printing pad 64, the printing pad 64 lifts the ink design 74 out of the reservoir 28 and retains the ink image 74 in a replication of the reservoir 28 on the printing pad 64. This is possible because the exposed surface 78 of the ink on the ink design 74 has become tacky. As the printing pad 64, which now holds the ink design 74, moves toward the object to be printed upon, fresh ink 63 is deposited onto the plate 20 and into the reservoir 28 defined on the pad printing plate 20.

Referring to FIGS. 10-12, once the ink is removed from the reservoir, the ink 74 proximate the tacky exposed surface 78 generally includes a second, newly exposed surface 80. Referring to FIG. 12, the newly exposed surface initially includes gaps 76 formed in the ink in the positions in which the glass beads 44 were prior to removing from the reservoir 28. The gaps 76 generally comprise semispherical shapes corresponding to the shapes of the exposed portions of the glass beads 44. Because the ink proximate the gaps 76 is generally still liquid, the gaps 76 will fill in once the ink design 74 is removed from the reservoir 28, thus forming a substantially uniform thickness of ink on the pad.

Referring to FIG. 9, because glass beads 44 are generally spherical, the only portions of the glass beads 44 up to and coplanar with the top surface 22 of the plate 20 or top margin 34 of the design reservoir 28 are very small points 46. These “points” 46 can form a minute “hole” in the ink design 74 when it is formed in the reservoir 28. However, once the ink design 74 is removed from the reservoir 28, the holes generally can fill when liquid ink flows to the holes. In addition, as described below, when the ink design 74 is pressed upon the object 72 to be printed upon, the ink “squishes” into the holes, thus effectively filling any areas where there is not ink in the ink design 74. This can enable the complete image 74 to be printed upon the object 72.

As described above, once the ink image 74 is removed from the reservoir 28, the newly exposed liquid ink surface 80 also becomes tacky. With the ink image 74 on the printing pad 64 being slightly tacky, the printing pad 64 descends to the object 72, presses upon the object 72, and transfers the ink replication 74 on the object 72. The ink image 74 is able to be transferred from the printing pad 64 because of the low relative surface energy of the silicone rubber printing pad 64 combined with the peeling effect imparted upon the image replication 74 on the printing pad 64 due to the shape of the printing pad 64.

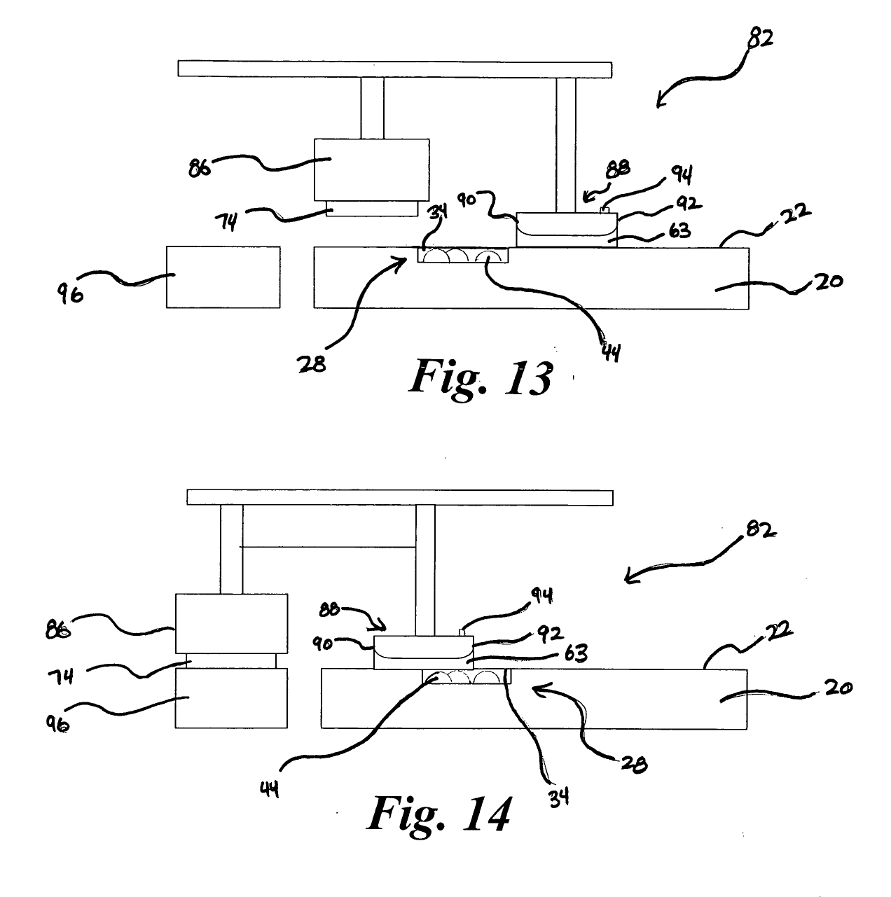

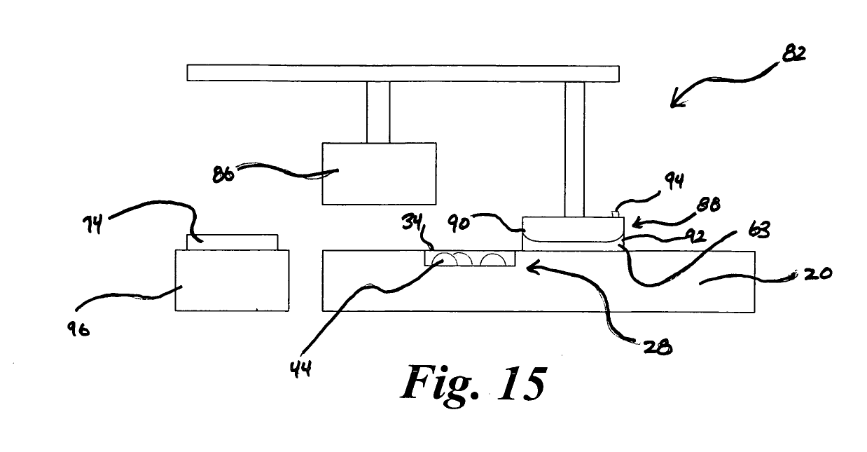

Referring to FIGS. 13-15, a sealed ink cup system 82 is depicted. A sealed ink cup system 82 generally comprises a pad printing plate 20 with a reservoir 28 defined therein. While the plate 20 depicted and described with respect to the sealed ink cup system 82 is the plate 20 according to the first embodiment, the plates according to the second and third embodiments 20′, 20″ can be used. The open inkwell pad printing system 60 also generally comprises an ink cup 88 having fore and aft cup lips 90, 92 defined thereon, the lips 90, 92 providing a blade for scraping excess ink off of the printing surface 22 and also a seal for sealing the cup 88 with respect to the plate 20. The cup 88 is operably engageable with the plate 20 and operably coupled to a printing pad 86. The cup 88 also can include a filling screw 94 presented thereon for filling the ink cup 88 with ink 63.

In pad printing processes using a sealed ink cup system, the printing pad 86 starts in a position with the ink cup 88 positioned over the reservoir 28 of the pad printing plate 20. The fore and aft lips 90, 92 of the cup 88 are moved over the pad printing plate top surface 22 and remove excess ink from the pad printing plate 20 while leaving the ink image 74 in the reservoir 28 up to the to margin 34. The glass beads 44 inhibit the ink design 74 from being removed from intermediate portions of the reservoir 28 during the scraping by the fore and aft lips 90, 92 of the cup 88.

The printing pad 86 is then placed onto the exposed, ink image 74. During this step, the remaining ink is retained in the ink cup 88. The printing pad 86 picks up the image 74 from the pad printing plate 20. The design reservoir 28 then generally is moved back under the sealed ink cup 88. The printing pad 86 pushes downward onto the object 96 to be printed upon and releases the ink image 74. At the same time, the pad printing plate 20 is exposed to new ink 63 inside the cup 88 such that the ink 63 fills into the design reservoir 28.

Referring again to FIGS. 8 and 9, as in the open inkwell system, the glass beads 44 inhibit the ink design 74 from being removed from intermediate portions of the reservoir 28 during the scraping. A reservoir 28 in a plate 20 having beads 44 is depicted. As can be seen, the top exposed surface 78 of the ink 74 in the reservoir 28 is generally level. In addition, the glass spheres depicted in FIGS. 8 and 9 can keep the printing pad off of the bottom of the reservoir, thus enabling ease of ink removal from the reservoir by a printing pad.

Although the plates and methods herein have been described with reference to particular embodiments, one skilled in the art will recognize that changes may be made in form and detail without departing from the spirit and the scope of the invention. For example, while the plate has been described as being used with ink, other printing media, such as melted polymers, could be used in conjunction with the plate without departing from the scope and spirit of the present invention. Therefore, the illustrated embodiments should be considered in all respects as illustrative and not restrictive. Any incorporation by reference of documents above is limited such that no subject matter is incorporated that is contrary to the explicit disclosure herein.

What is claimed is:

1. A composite printing plate comprising:
a body having a first surface and a generally opposed printing surface, the body comprising a polymeric matrix and a filler dispersed in the polymeric matrix, the filler comprising a plurality of beads; and
a design selectively presented in the printing surface, wherein at least some of the beads are at least partially exposed in the design at the printing surface.

2. The plate of claim 1, wherein outer margins of the printing surface are generally coplanar and wherein exposed surfaces of one or more beads are generally coplanar with the coplanar outer margins.

3. The plate of claim 1, wherein the beads are generally spherical.

4. The plate of claim 1, wherein the polymeric matrix is selected from the group consisting of: thermosets, thermoplastics, copolymers thereof, and blends thereof.

5. The plate of claim 1, wherein the polymeric matrix is selected from the group consisting of: acetal, PBT (polybutylene terephthalate), PET (polyethylene terephthalate) copolymers thereof, and blends thereof.

6. The plate of claim 1, wherein the beads comprise a composition selected from the group consisting of: an oxide glass, elemental iron, an iron alloy, and any combinations thereof.

7. The plate of claim 1, wherein the plate comprises between about 20 wt. % and about 90 wt. % of the beads.

8. The plate of claim 1, wherein the plate comprises between about 30 wt. % and about 60 wt. % of the beads.

9. The plate of claim 1, wherein the plate comprises between about 45 wt. % and about 55 wt. % of the polymeric matrix.

10. The plate of claim 1, wherein the beads are substantially homogeneously dispersed in the polymeric matrix.

11. The plate of claim 1, wherein a concentration of the beads is greater proximate the printing surface than proximate the first surface.

12. The plate of claim 1, wherein the filler further comprises particles comprised of an elemental metal selected from the group consisting of: iron, any alloys thereof, and any combinations thereof.

13. The plate of claim 12, wherein a concentration of the beads is greater proximate the printing surface than proximate the first surface and a concentration of the particles is greater proximate the first surface than proximate the printing surface.

14. The plate of claim 13, wherein the beads comprise glass and the particles comprise elemental iron and any alloys thereof.

15. The plate of claim 12, wherein the filler comprises between about 40 wt. % and about 60 wt. % of the beads and between about 40 wt. % and about 60 wt. % of the particles.

16. The plate of claim 12, wherein the filler comprises between about 45 and about 55 wt. % of the beads and between about 45 wt. % and about 55 wt. % of the particles.

17. The plate of claim 12, wherein the particles comprising the elemental metal comprise average particle dimensions between about 0.005 inches and about 0.010 inches.

18. The plate of claim 1, wherein the beads are spherical and comprise average particle diameters between about 0.0004 inches and about 0.0039 inches.

19. The plate of claim 1, wherein the beads pass through sieve having mesh sizes between about mesh size 18 and about mesh size 400.

20. The plate of claim 1, wherein the beads pass through sieve having mesh sizes between about mesh size 100 and about mesh size 200.

21. The plate of claim 1, further comprising a binding agent associated with the beads, wherein the binding agent comprises an adhesive that adheres to the surface of the beads and adhesively bonds the beads with the polymer of the matrix.

22. A process of making a printing plate comprising providing a body formed of a polymer matrix and beads dispersed in the polymeric matrix and etching a design into the body to form a printing surface thereon, such that at least some of the beads are at least partially exposed in the design.

23. The process of claim 22, further comprising selecting the beads from the group consisting of: an oxide glass, elemental iron, an iron alloy, and any combinations thereof.

24. The process of claim 22, further comprising selecting the polymeric matrix from the group consisting of: thermosets, thermoplastics, copolymers thereof, and blends thereof.

25. The process of claim 22, further comprising selecting the polymeric matrix from the group consisting of: acetal, PBT (polybutylene terephthalate), PET (polyethylene terephthalate), copolymers thereof, and blends thereof.

26. The process of claim 22, further comprising performing the etching using a laser.

27. A method of transferring an ink design onto a substrate comprising:
providing a first substrate having a body comprising a first surface and a generally opposed printing surface, the body comprised of a polymeric matrix and beads dispersed in the polymeric matrix, the body having a design selectively presented in the printing surface, wherein at least some of the beads are at least partially exposed in the design at the printing surface;
at least partially filling the design with ink; and
moving a printing pad relative to the ink to transfer ink from the design to the printing pad.

28. The method of claim 27, where the first substrate comprises a printing pad that is substantially non-absorbent of the ink and the method further comprising transferring at least a portion of the ink from the printing pad to a second substrate.

29. The method of claim 27, further comprising providing one or more scrapers operably engageable with the printing surface and effecting movement of the scrapers relative to the printing surface to remove ink, the partially exposed beads reducing the amount of ink removed by the scrappers from the design relative to an equivalent design without the beads.

30. The method of claim 27, further comprising providing particles dispersed in the polymeric matrix, the particles selected from the group consisting of: iron, steel, any alloys thereof, and any combinations thereof and operably magnetically coupling the first substrate to printing equipment.
